(19) United States
(12) Patent Application Publication
(10) Pub. No.: US 2011/0182448 A1
(43) Pub. Date: Jul. 28, 2011

(54) SPACER-INTEGRATED DIAPHRAGM FOR CONDENSER MICROPHONE

(76) Inventors: Won-Taek Lee, Incheon (KR); Chang-Won Kim, Incheon (KR); Jung-Min Kim, Incheon (KR); Hyung-Joo Kim, Incheon (KR)

(21) Appl. No.: 12/993,315

(22) PCT Filed: May 13, 2009
(86) PCT No.: PCT/KR2009/002528

§ 371 Date: Mar. 18, 2011

(30) Foreign Application Priority Data
May 19, 2008 (KR) 20-2008-0006471

(51) Int. Cl. H04R 1/00

(52) U.S. Cl. 381/174

(57) ABSTRACT

The present invention relates to a spacer-integrated diaphragm, in which spacers are integrated with the diaphragm, in order to reduce the number of components and manufacturing processes needed and remove parasitic capacitance. A characterizing feature of the spacer-integrated diaphragm of the present invention is that it has an integrated structure comprising a diaphragm of a flat conductive film, and thermally insulative spacers formed so as to protrude on peripheral portions of the diaphragm through a PSR (Photo Solder Resist) printing process. The spacers are formed with a plurality of holes to remove parasitic capacitance, the diaphragm has a rectangular flat shape with round edges, and the spacers are formed near the four edges of the rectangular flat shape. In the spacer-integrated diaphragm of the present invention, because the spacers are formed of a PSR (Photo Solder Resist) material and are also formed with a plurality of holes, the present invention can prevent unnecessary parasitic capacitance from occurring and improve sound quality, and, because the diaphragm and the spacers are integrally formed, the present invention can reduce the number of processes needed when a condenser microphone is assembled and reduce the number of components required, thereby reducing manufacturing costs.

### BACKGROUND OF THE INVENTION

1. Field of the Invention

The present invention relates to a condenser microphone, and more particularly, to a spacer-integrated diaphragm in which a spacer and a diaphragm are integrated in one body to reduce the number of components and manufacturing processes, thereby reducing manufacturing costs of a microphone.

2. Description of the Related Art

As shown in FIG. 1, a typical condenser microphone 10 includes a case 11 formed of a cylindrical metal having a sound hole 11a in a front plate thereof, a polar ring 12 formed of a conductive material, a diaphragm 13, a spacer 14, a first base 15 (referred to as an insulating base) formed of an insulating material and having a ring shape, a fixed electrode facing the diaphragm 13 with the spacer 14 therebetween, a second base 17 (referred to as a conductive base) formed of a conductive material, and a printed circuit board (PCB) 18 on which a circuit part is mounted and a connection terminal is disposed. Typically, the above-described parts are sequentially stacked within the case 11, and then, an end of the case 11 is curled to manufacture the condenser microphone 10. Here, the polar ring 12 and the diaphragm 13 may adhere to each other to become an integrated unit. In case of an electret-type microphone, the fixed electrode 16 may have a structure in which a polymer film is attached to the metal plate to form an electret.

A typical condenser microphone has a structure in which a diaphragm and a spacer are separated from each other, and the spacer is generally formed of an insulative polymer film.

However, in case where the spacer is formed of the polymer film, since the polymer film has self-permittivity, parasitic capacitance may occur to act as unnecessary capacitance. Therefore, there is a limitation that sensitivity of the microphone may be decreased.

### SUMMARY OF THE INVENTION

Accordingly, the present invention is directed to a spacer-integrated diaphragm for a condenser microphone that substantially obviates one or more problems due to limitations and disadvantages of the related art.

An object of the present invention is to provide a spacer-integrated diaphragm in which a spacer is integrated with a diaphragm to reduce the number of assembling processes.

Another object of the present invention is to provide a spacer-integrated diaphragm having a structure in which a photo solder resist (PSR) is screen-printed on a diaphragm to realize a spacer, thereby preventing parasitic capacitance from occurring.

According to an aspect of the present invention, there is provided a spacer-integrated diaphragm for a condenser microphone, the spacer-integrated diaphragm including: a diaphragm formed of a flat conductive film; and an insulative spacer formed of a protruding photo solder resist material in which a plurality of holes is defined, the insulative spacer being integrated with peripheral portions of the diaphragm to remove parasitic capacitance.

The diaphragm may have a rectangular flat shape with rounded edges, and the spacer may be disposed near each of the four edges of the rectangular flat shape.

According to another aspect of the present invention, there is provided a spacer-integrated diaphragm for a condenser microphone, the spacer-integrated diaphragm including: a diaphragm formed of a flat conductive film; and an insulative spacer formed of a polymer film in which a plurality of holes is defined, the insulative spacer being integrated with peripheral portions of the diaphragm to remove parasitic capacitance.

### BRIEF DESCRIPTION OF THE DRAWINGS

FIG. 1 is a side sectional view of a typical condenser microphone applicable to the present invention.

FIG. 2 is a perspective view of a spacer-integrated diaphragm according to an embodiment of the present invention.

FIG. 3 is a plan view illustrating the spacer-integrated diaphragm of FIG. 2.

FIG. 4 is a flowchart illustrating a process of manufacturing a spacer-integrated diaphragm according to an embodiment of the present invention.

FIG. 5 is a perspective view of a spacer-integrated diaphragm according to another embodiment of the present invention.

### DETAILED DESCRIPTION OF THE INVENTION

Technical objectives of the present invention will become evident through the following embodiments. The following embodiments are merely illustrative of the present invention, and thus, this should not be construed as limited to the scope of the present invention.

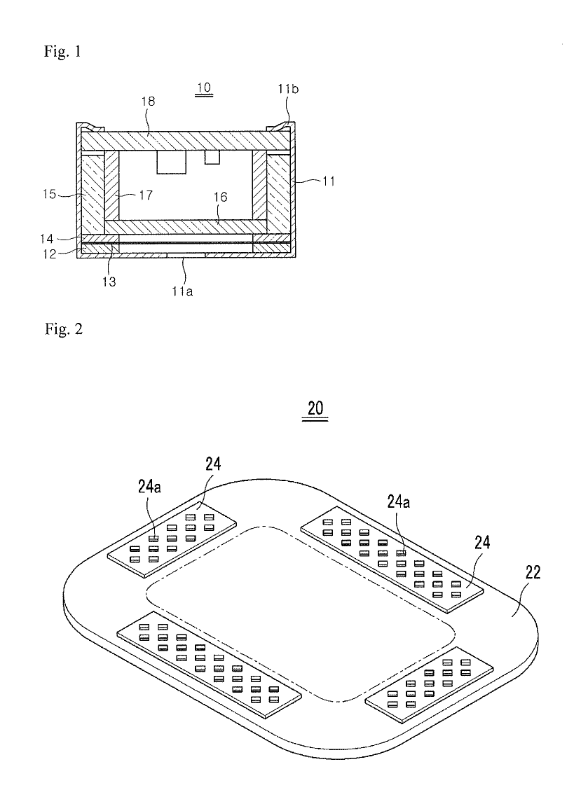

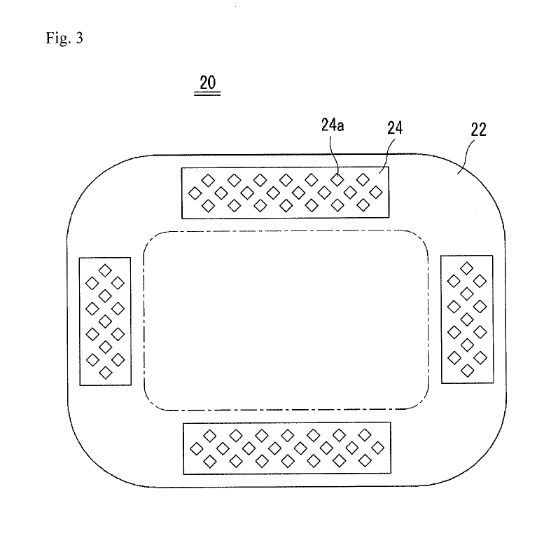

FIG. 2 is a perspective view of a spacer-integrated diaphragm 20 according to an embodiment of the present invention, and FIG. 3 is a plan view illustrating the spacer-integrated diaphragm 20 of FIG. 2.

As shown in FIGS. 2 and 3, the spacer-integrated diaphragm 20 according to an embodiment of the present invention includes a rectangular flat type diaphragm 22 having rounded edges and spacers 24 respectively protruding from peripheral portions of four sides of the diaphragm 22 through a photo solder resist (PSR) printing process.

Referring to FIGS. 2 and 3, the diaphragm 22 may be a conductive diaphragm vibrated by a sound pressure introduced through sound holes in a condenser microphone. The spacers 24 protrude from the four sides of the rectangular diaphragm 22 to maintain a distance between a back plate and the diaphragm 22, respectively. Specifically, each of the spacers 24 according to the present invention is formed of a PSR material, which is printed on the diaphragm 22. Also, a plurality of holes 24a is defined in the spacer 24 to remove parasitic capacitance.

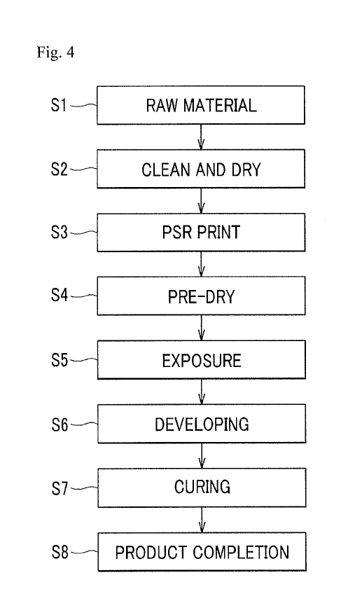

A process of manufacturing the spacer-integrated diaphragm 20 according to an embodiment of the present invention is illustrated in FIG. 4.

FIG. 4 is a flowchart illustrating a process of manufacturing a spacer-integrated diaphragm according to an embodiment of the present invention.

Referring to FIG. 4, a raw material to be used as a diaphragm is prepared in step S1. In step S2, the raw material is cleaned and dried to prepare a PSR print. Then, in step S3, masks in which holes are defined respectively cover four sides of the diaphragm. In step S4, a PSR ink is printed on the prepared raw material. Thereafter, in steps S5 and S6, the raw material on which the PSR ink is printed is pre-dried to expose the pre-dried raw material to ultraviolet (UV) rays and develop the raw material exposed to the UV rays. Then, in steps S7 and S8, the developed raw material is fully cured to form a spacer-integrated diaphragm product.

As described above, in the spacer-integrated diaphragm 20, since the spacer 24 is formed of the PSR material and has the plurality of holes, the spacer 24 has an area less than that of a conventional spacer to remove the parasitic capacitance. In addition, since the diaphragm 20 and the spacer 24 are integrated in one body, the number of processes may be reduced when the condenser microphone is assembled, and the number of components may be reduced to reduce manufacturing costs.

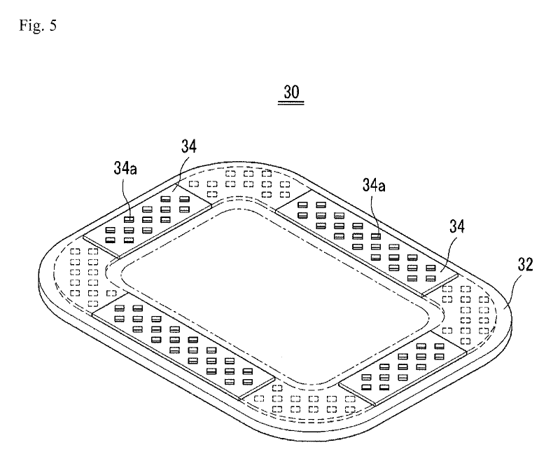

FIG. 5 is a perspective view of a spacer-integrated diaphragm according to another embodiment of the present invention. A polymer film in which a plurality of holes is defined is used as a spacer.

Referring to FIG. 5, in a spacer-integrated diaphragm 30 according to another embodiment of the present invention, a spacer 34 formed of a polymer film in which a plurality of holes 34a is defined is attached to a diaphragm 32 to integrate the space 34 and the diaphragm 32 with each other. According to another embodiment of the present invention, since the holes 34a is formed in the polymer film using a mechanical process (e.g., punching process) to reduce an area of the polymer film constituting the spacer 34, parasitic capacitance due to self-permittivity of the polymer film may be removed.

As described above, when the spacer 34 is manufactured using the polymer film having the plurality of holes 34a, a spacer in which a plurality of holes is defined in a ring-shaped polymer film may be used, like a conventional spacer. Alternatively, as the solid line shown in FIG. 5, the spacers 34 divided into four pieces may be respectively attached to the four sides of the diaphragm 32.

In the spacer-integrated diaphragm of the present invention, since the spacers are formed of the PSR material and also formed with the plurality of holes, the present invention can prevent unnecessary parasitic capacitance from occurring to improve sound quality. Also, since the diaphragm and the spacers are integrally formed, the present invention can reduce the number of processes when the condenser microphone is assembled. In addition, the number of components can be reduced to reduce the manufacturing costs.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A spacer-integrated diaphragm for a condenser microphone, the spacer-integrated diaphragm comprising:
a diaphragm formed of a flat conductive film; and
an insulative spacer formed of a protruding photo solder resist material in which a plurality of holes is defined, the insulative spacer being integrated with peripheral portions of the diaphragm to remove parasitic capacitance.

2. The spacer-integrated diaphragm of claim 1, wherein the diaphragm has a rectangular flat shape with rounded edges, and the spacer is disposed near each of the four edges of the rectangular flat shape.

3. A spacer-integrated diaphragm for a condenser microphone, the spacer-integrated diaphragm comprising:
a diaphragm formed of a flat conductive film; and
an insulative spacer formed of a polymer film in which a plurality of holes is defined, the insulative spacer being integrated with peripheral portions of the diaphragm to remove parasitic capacitance.
